(19) United States
(12) Patent Application Publication
(10) Pub. No.: US 2006/0140191 A1
(43) Pub. Date: Jun. 29, 2006

(54) Multi-level scheduling using single bit vector

(76) Inventor: Uday R. Naik, Fremont, CA (US)

Correspondence Address: Ryder IP Law, PC;PortfolioIP, P.O. Box 52050, Minneapolis, MN, 55402, US

(21) Appl. No.: 11/024,883

(22) Filed: Dec. 29, 2004

(51) Int. Cl. H04L 12/56; H04L 12/28

(52) U.S. Cl. 370/395.4; 370/412

(57) ABSTRACT

In general, in one aspect, the disclosure describes an apparatus that includes a multi-level queue structure to store data. The multi-level queue structure includes a plurality of queues segregated into more than one priority level. The apparatus further includes a scheduler to schedule transmission of the data from said multi-level queue structure. The scheduler performs multi-level scheduling of the multi-level queue structure utilizing a single data bit vector organized by priority. The single data bit vector indicates occupancy status of associated queues.

### BACKGROUND

Store-and-forward devices (e.g., routers) receive data (e.g., packets), process the data and transmit the data. The processing may be simple or complex. The processing may include routing, manipulation, and computation. Queues (buffers) are used to hold packets while the packets are awaiting transmission. The packets received may include parameters defining at least some subset of initiation point, destination point, type of data, class of data, and service level. Based on these parameters the packets may be assigned a particular priority and/or weight. Accordingly, the devices contain a plurality of queues and the packets are enqueued in an appropriate queue based on destination and priority.

Scheduling the transmission of the packets from the queues (dequeuing the packets from the queue) to the intended destination may be based on the priorities and/or weights. If scheduling is based on priority, then the queues holding higher priority packets (high priority queues) will be dequeued before the queues holding lower priority packets (low priority queues). If the scheduling is based on weights, and a first queue has a weight of one and a second queue has a weight of two, then the second queue will have twice as many dequeues (2 for every one) as the first queue.

The queues may be grouped based on priority (or weight) and then within each group be assigned a weight (or priority). This grouping of queues generates a queue hierarchy. For example, you have two groups of queues (a high priority group and a low priority group) and within each priority the individual queues are assigned weights. For a queue hierarchy the scheduling may be done on a hierarchical basis and may require hierarchical (multi-level) scheduling. For example, the high priority queues would be dequeued before the low priority queues and the queues with higher weights within the group would be dequeued more then the queues with lower weights.

A multi-level hierarchy typically requires different data structures and processing for each level of the hierarchy, which is computationally expensive. One of the key challenges in scheduling packets at high data rates is the ability to implement a multi-level hierarchical scheduler efficiently.

### DESCRIPTION OF FIGURES

FIG. 1 illustrates an exemplary block diagram of a system utilizing a store-and-forward device, according to one embodiment;

FIG. 2 illustrates a block diagram of an exemplary store and-and-forward device, according to one embodiment;

FIG. 3 illustrates an exemplary hierarchical queue structure and an associated hierarchical bit vector, according to one embodiment;

FIG. 4 illustrates an exemplary hierarchical queue structure and an associated single bit vector, according to one embodiment;

FIG. 5 illustrates an exemplary process flow for selecting a next queue, according to one embodiment;

FIG. 6 illustrates an exemplary update of bit vectors as packets are dequeued, according to one embodiment; and

FIG. 7 illustrates an exemplary process flow for selecting a next queue, according to one embodiment.

### DETAILED DESCRIPTION

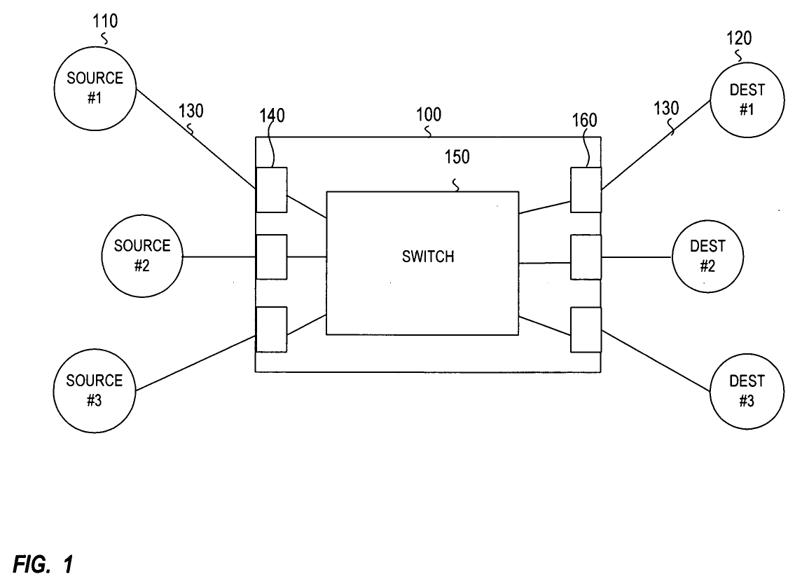

FIG. 1 illustrates an exemplary block diagram of a system utilizing a store-and-forward device 100 (e.g., router, switch). The store-and-forward device 100 may receive data from multiple sources 110 (e.g., computers, other store and forward devices) and route the data to multiple destinations 120 (e.g., computers, other store and forward devices). The data may be received and/or transmitted over multiple communication links 130 (e.g., twisted wire pair, fiber optic, wireless). The data may be received/transmitted with different attributes (e.g., different speeds, different quality of service). The data may utilize any number of protocols including, but not limited to, Asynchronous Transfer Mode (ATM), Internet Protocol (IP), and Time Division Multiplexing (TDM). The data may be sent in variable length or fixed length packets, such as cells or frames.

The store and forward device 100 includes a plurality of receivers (ingress modules) 140, a switch 150, and a plurality of transmitters 160 (egress modules). The plurality of receivers 140 and the plurality of transmitters 160 may be equipped to receive or transmit data (packets) having different attributes (e.g., speed, protocol). The switch 150 routes the packets between receiver 140 and transmitter 160 based on the destination of the packets. The packets received by the receivers 140 are stored in queues (not illustrated) within the receivers 140 until the packets are ready to be routed to an appropriate transmitter 160. The queues may be any type of storage device and preferably are a hardware storage device such as semiconductor memory, on chip memory, off chip memory, field-programmable gate arrays (FPGAs), random access memory (RAM), or a set of registers. A single receiver 140, a single transmitter 160, multiple receivers 140, multiple transmitters 160, or a combination of receivers 140 and transmitters 160 may be contained on a single line card (not illustrated). The line cards may be Ethernet (e.g., Gigabit, 10 Base T), ATM, Fibre channel, Synchronous Optical Network (SONET), Synchronous Digital Hierarchy (SDH), various other types of cards, or some combination thereof.

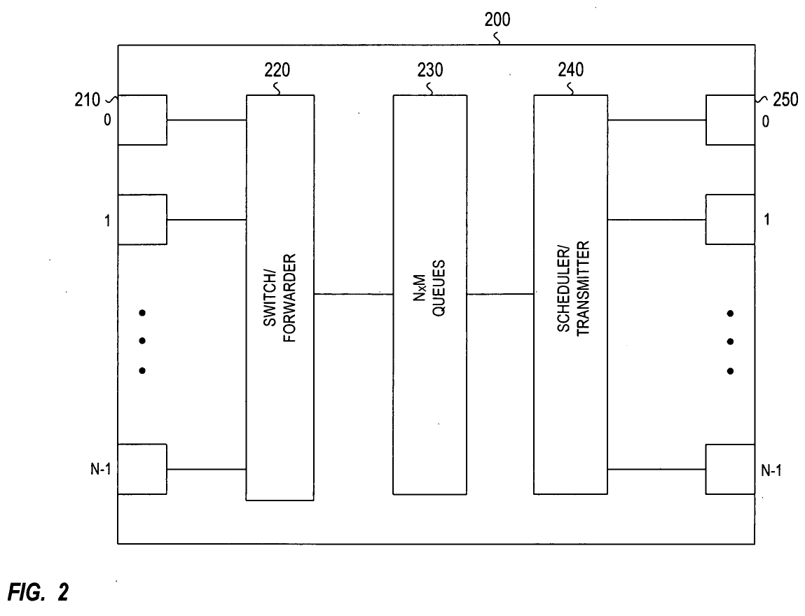

FIG. 2 illustrates a block diagram of an exemplary store and-and-forward device 200 (e.g., 100 of FIG. 1). The store-and-forward device 200 includes a plurality (N) of receive ports 210, a switch/forwarder 220, a plurality of queues 230, a scheduler/transmitter 240, and a plurality (N) of transmit ports 250. Data (packets) from external sources are received by the N receive ports 210 (labeled 0 to N−1). The switch/forwarder 220 analyzes the packets to determine the destination and priority associated with the packets and places the packets in an associated queue 230. The scheduler/transmitter 240 selects the appropriate queue(s) for dequeuing packets and transmits the packets to external sources via an associated transmit port 250. It should be noted that each destination need not have a queue 240 for each priority level.

In order for the scheduler 240 to schedule the dequeuing of packets from the queues, the scheduler 240 needs to know which queues contain data (at least one packet). The scheduler 240 may utilize a bit vector to keep track of the queues that contain data. The bit vector includes a bit for each queue, with the queue being set (e.g., to ‘1’) if the queue contains data.

If the packets have N possible destinations and M possible priorities per destination then there is a total of N×M possible flows. Accordingly, there will be N×M queues 230, one queue associated with each possible flow. The queues 230 containing higher priority packets (higher priority queues) will be given preference over the queues 230 containing lower priority packets (lower priority queues). If we assume that there are 4 priority level queues (levels 1-4), priority 1 queues will be handled first, followed by level 2 and so on. Within the priority levels the queues are dequeued according to a scheduling algorithm (e.g., a round-robin (RR)). The queues may maintain a data count that indicates how much data is in the queue (e.g., how many packets).

In order for the scheduler 240 to schedule the dequeuing of packets from the different priority queues, the scheduler 240 needs to know which priority levels have queues containing packets. The scheduler 240 may utilize a hierarchical bit vector to track this. The hierarchical bit vector may include a bottom level that tracks the occupancy status (does it contain packets) of the queues. The queues associated with a particular priority level are then ORed together so that a single bit at an upper level indicates if at least one queue at that priority level contains data (has at least one packet). The scheduler would determine the highest priority level having queues containing packets by analyzing the upper level of the hierarchical bit vector (e.g., finding first active bit). The scheduler would then proceed to schedule queues within that priority level based on the scheduling algorithm for that priority level (e.g., RR).

The queues within a priority level may be assigned weights. The weights can be used to have certain queues processed (packets dequeued therefrom) more then offers. For example, if you have 4 queues within a certain priority level (queues 0-3) and queues 0-2 have a weight of 1 and queue 3 has a weight of 2, queue 3 will dequeue twice as much data (e.g., twice as many packets) as the other queues (assuming the queue has packets to be dequeued). The queues may use a credit count to keep track of remaining dequeues (weight−previous dequeues) during the scheduling algorithm (e.g., weighted RR (WRR)).

Once the scheduler selects a priority level (e.g., based on upper level of hierarchical data bit vector) the scheduler may use a credit bit vector to track the queues within that priority level that have remaining credit. The scheduler will use the data and credit bit vectors for that priority level to select the queues for dequeuing.

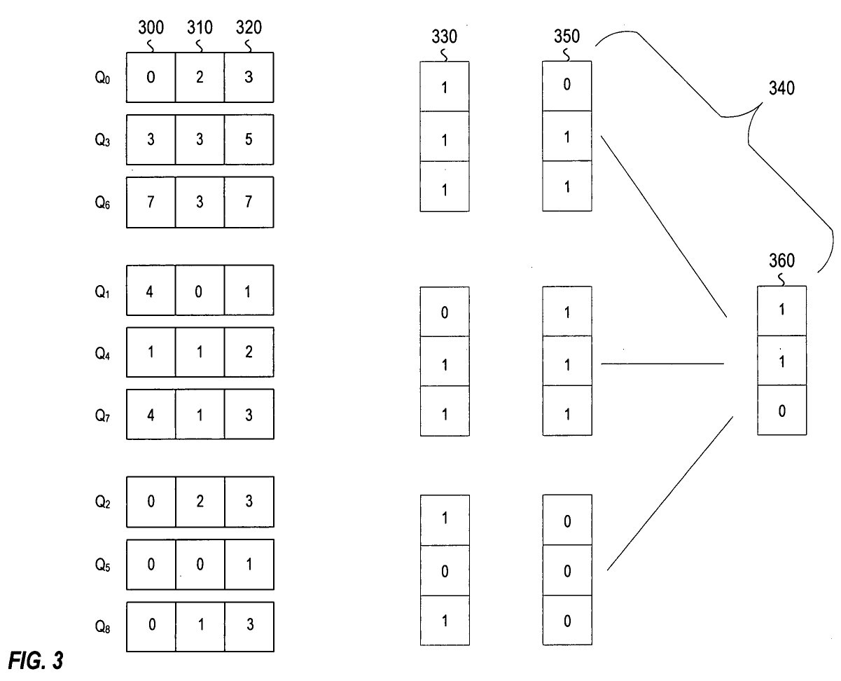

FIG. 3 illustrates an exemplary hierarchical queue structure (e.g., priority, weight) and an associated hierarchical bit vector. The hierarchical queue structure includes 9 queues (3 for each of 3 priorities) and each queue includes a data count 300, a credit count 310 and a weight 320. The associated hierarchical bit vector utilized by a scheduler includes a separate credit bit vector 330 for each priority level and a hierarchical data bit vector 340. The hierarchical data bit vector 340 includes a separate data bit vector 350 for each priority level and a higher level data bit vector 360 that includes a bit for each priority level, where the bit summarizes the occupancy status for the priority (whether any queues at that priority level contain packets). As illustrated, the data 300, credit 310 and weight 320 counts for the queues are numeric for ease of understanding. The counts are likely defined by digital numbers with the number of bits for the counts 300, 310, 320 being based on maximum values possible for the counts.

The scheduler for the hierarchical queue structure (e.g., schedule by priority, and by weight within each priority) processes each level of the hierarchy, which may be computationally expensive and not efficient. For example, the scheduler would first determine the highest priority level having at least one queue with at least one packet (in this case priority 1 queues) and then would proceed to analyze the credit and data bit vectors 330, 350 for that priority level to determine which queues to dequeue.

In an alternative embodiment, the credit bit vector 330 may also include a higher level credit bit vector (not illustrated) that includes a bit for each priority level, where the bit summarizes the credit status for the priority (whether any queues at that priority level have credit). The scheduler would determine the highest priority level having both data and credit (AND of the higher level data bit vector 360 and the higher level credit bit vector).

Collapsing the data structure for multiple levels into a single level, utilizing a single data bit vector and a single credit bit vector for all queues (regardless of priority), and utilizing a priority mask would enable an algorithm to achieve considerable computation efficiencies and be elegant to implement for a multi-level hierarchical queue structure (e.g., dequeue by priority and weight).

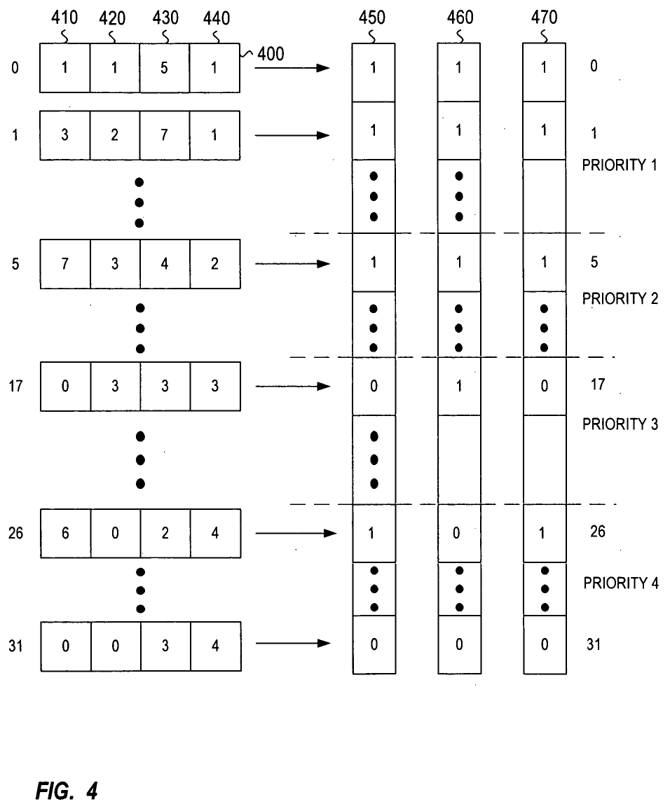

FIG. 4 illustrates an exemplary hierarchical queue structure (e.g., priority, weight) and associated data and credit bit vectors. The hierarchical queue structure includes 32 queues 400 having 4 strict-priority levels (queues 0 to 4 being priority level 1, queues 5 to 16 being priority level 2, queues 17 to 25 being priority level 3, and queues 26 to 31 being priority level 4). The queues 400 maintain, in an array in local memory, a count of packets in the queue (queueCount) 410, a count of credits in the queue (queueCredit) 420, a weight for the queue (queueWeight) 430, and a mask identifying level for the queue (queueLevelMask) 440 (discussed in more detail later). The queueCount 410, the queueCredit 420, the queueWeight 430, and the queueLevelMask 440 are illustrated numerically for ease of understanding.

A scheduler utilizes a single data bit vector (queuesWithDataVector) 450 to identify queues within the hierarchical queue structure that have at least one packet stored therein. The scheduler utilizes a single credit bit vector (queuesWithCreditVector) 460 to identify queues within the hierarchical queue structure that have credits remaining. For example, queue 0 has 1 packet (data 410=1) and has 1 credit (credit 420=1) so the bit associated with queue 0 in the data bit vector 450 as well as the bit associated with queue 0 in the credit bit vector 460 are activated (e.g., set to 1). Queue 17 has no packets (data 410=0) and has 3 credits (credit 420=3) so that the bit associated with queue 17 in the data bit vector 450 is not activated (e.g., set to 0) while the bit associated with queue 17 in the credit bit vector 460 is activated (e.g., set to 1). Queue 26 has 6 packets (data 410=6) and has no credits (credit 420=0) so that the bit associated with queue 26 in the data bit vector 450 is activated (e.g., set to 1) while the bit associated with queue 26 in the credit bit vector 460 is not activated (e.g., set to 0). Queue 31 has no packets (data 410=0) and no credits (credit 420=0) so that the bit associated with queue 31 in the data bit vector 450 and the credit bit vector 460 are not activated (e.g., set to 0).

The bit vectors 450, 460 are organized by priority, from high to low priority. Organizing the bit vectors 450, 460 by priority will ensure that a find first bit set (FFS) instruction will find a queue in the high priority levels first. The FFS is an instruction added to many processors to speed up bit manipulation functions. The FFS instruction looks at a word (e.g., 32 bits) at a time to determine the first bit set (e.g., active, set to 1) within the word if there is a bit set within the word. If a particular word does not have a bit set, the FFS instruction proceeds to the next word.

Note the queues in this example are organized numerically by priority (e.g., priority level 1—queues 0-5) and that the bit vectors 450, 460 therefore proceed numerically in order. This was done simply for ease of understanding, and is not limited thereto. For example, the queues could be organized numerically by destination (e.g., destination 1—queues 0-4). Regardless of the how the queues are organized the bit vectors need to be aligned by priority. For example, if there were six queues having 2 destinations and 3 priorities and the queues were organized by destination (e.g., queue 0—destination 1, priority 1; queue 1—destination 1, priority 2; queue 2—destination 1, priority 3) then organizing the bit vectors 450, 460 by priority would result in a bit vector that started with queues 0, 3 (priority 1) and ended with queues 2, 5 (priority 3).

When packets are enqueued to a particular queue 400, the data count 410 for the queue 400 is incremented (e.g., by 1). For example, if queue 5 received an additional packet, the data count 410 would be increased to 8. If there was no packets in the queue 400 prior to the enqueuing, then the corresponding bit in the data bit vector 450 will be activated. For example, if queue 17 received a packet the data count 410 would be increased to 1 and the corresponding bit in the data bit vector 450 would be activated.

When data is dequeued from a particular queue 400 both the data count 410 and the credit count 420 are decremented (e.g., by 1). For example, if queue 1 had a packet dequeued, the data count 410 would be reduced to 2 and the credit count 420 would be reduced to 1. If after the dequeue, there are no packets remaining in the queue 400 (data 410=0), then the associated bit in the data bit vector 450 is deactivated. Likewise if after the dequeue, there are no credits remaining in the queue 400 (credit 420=0) then the associated bit in the credit bit vector 460 is deactivated. For example, if queue 0 had a packet dequeued, the data count 410 and the credit count 420 would be reduced to 0 and the associated bit in both the data bit vector 450 and the credit bit vector 460 would be deactivated.

According to one embodiment, after the credits are used for a certain queue and the associated bit in the credit bit vector 460 is cleared, the credit count 420 is reset (set to weight 430). For example, after the credit count 420 for queue 0 has been reduced to 0 and the associated bit in the credit bit vector 460 was deactivated, the credit count 420 for queue 0 would be reset to the weight 430 (e.g., reset to 5).

When it is time to perform a dequeue, a determination needs to be made as which queue (and priority level) to dequeue packets from. An FFS instruction may be performed on the data bit vector 450 to determine highest priority queue (and thus priority group) having data (at least one packet). In this case, queue 0 is the first queue having data so that the priority 1 queues would be the first queues to be dequeued. As previously noted, organizing the bit vectors 450, 460 by priority ensures high priority level queues having data are selected first.

Alternatively, an FFS instruction may performed on an AND 470 of the two bit vectors 450, 460 to determine a first queue that has both data and credit. For example, queue 0 has both data and credit so the AND of the two bits 470 is activated (performing an FFS on the AND 470 would result in a determination that queue 0 and thus priority 1 queues were the first queues 400 to dequeue). By contrast queue 17 has credit but no data, queue 26 has data but no credit, and queue 31 has neither data no credit so the AND for each of these queues is not active. As previously noted, organizing the bit vectors 450, 460 by priority ensures high priority level queues having both data and credits are selected first.

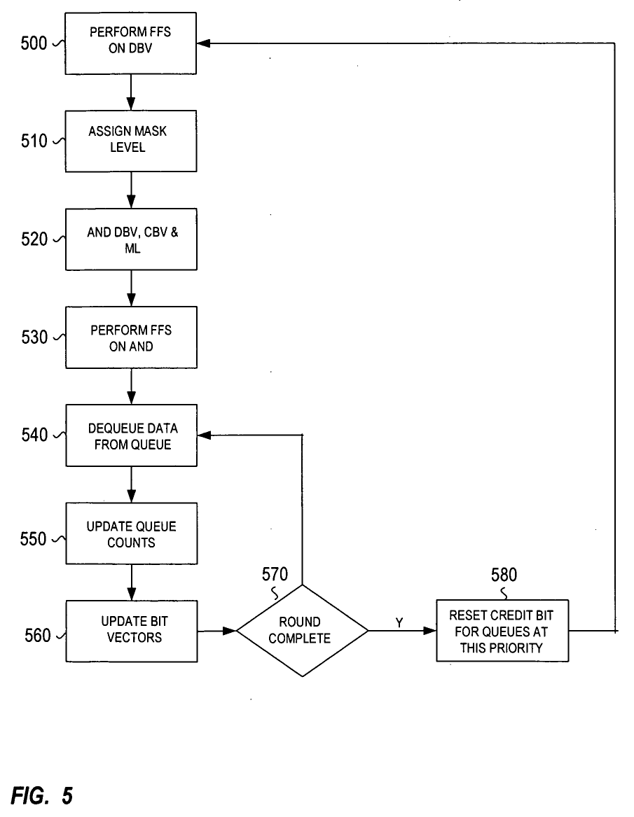

FIG. 5 illustrates an exemplary process flow for dequeuing packets from a hierarchical queue structure. An FFS instruction is performed on the data bit vector to determine the first queue (and associated priority level) that has data 500. As previously noted the bit vectors are organized by priority so the FFS operation will find the highest priority queues having data. Once the queue (and priority) is determined the applicable mask level is assigned 510. The mask level is a bit vector that has a bit associated with each queue, the bits associated with the selected priority being active (set to 1) and the remaining bits which are associated with all other queues are deactive (set to 0). The data bit vector, the credit bit vector and the mask level are ANDed together 520. A resulting AND bit vector having only bits associated with queues at the selected priority level (the mask level filters out all other priority levels) that have both data and credit being active. An FFS instruction is performed on the AND bit vector to determine the first queue at the associated priority level that has data and credit 530.

A packet is dequeued from the selected queue 540 and the data and credit counts for the queue are updated 550. For example if queue 5 from FIG. 4 was selected and a packet was dequeued, the data count 410 would be decremented by 1 to 6 and the credit count 420 would be decremented by 1 to 2.

After the queue counts are updated, the data and credit bit vectors are updated, if required 560. For example, after a packet was dequeued from queue 5 of FIG. 4 no updates to the data and credit bit vectors 450, 460 would be required. However if a packet was dequeued from queue 0, the data and credit counts 410, 420 would be reduced to 0 (no packets or credits remaining) so that the bits associated with the queue in the data and credit bit vectors 450, 460 would be updated (set to 0). It should be noted that the credit count for the queue may be set back to the weight after all the credits are used and the credit bit vector is deactivated for the queue. Moreover, if the credit bit vector is deactivated for the queue and the queue still has data then the credit bit vector may be reset.

After the bit vectors are updated 560, if required, a determination will be made as to whether the round is complete for the selected priority level (whether there are any other queues at the priority level that have both data and credit) 570. The determination 570 includes ANDing the data bit vector and the mask level to determine if there are any queues in that priority level that have data. Alternatively the determination 570 may include ANDing the data bit vector, the credit bit vector and the mask level to determine if there are any queues in that priority level that have data and credit. As the credit bit vector for a particular queue may be reset if the queue still has data it may produce the same result is the same as ANDing just the data bit vector and the mask level.

If the round is complete (570 Yes) indicating that there are no queues within the priority level having data (or data and credit) the credit bits for the queues at that priority level are reset (e.g., set to 1) 580 and the process returns to 500. If the round is not complete (570 No) indicating that there is at least one queue at the priority level having data (or data and credit), then the next queue for that priority is dequeued according to the scheduling algorithm (e.g., WRR).

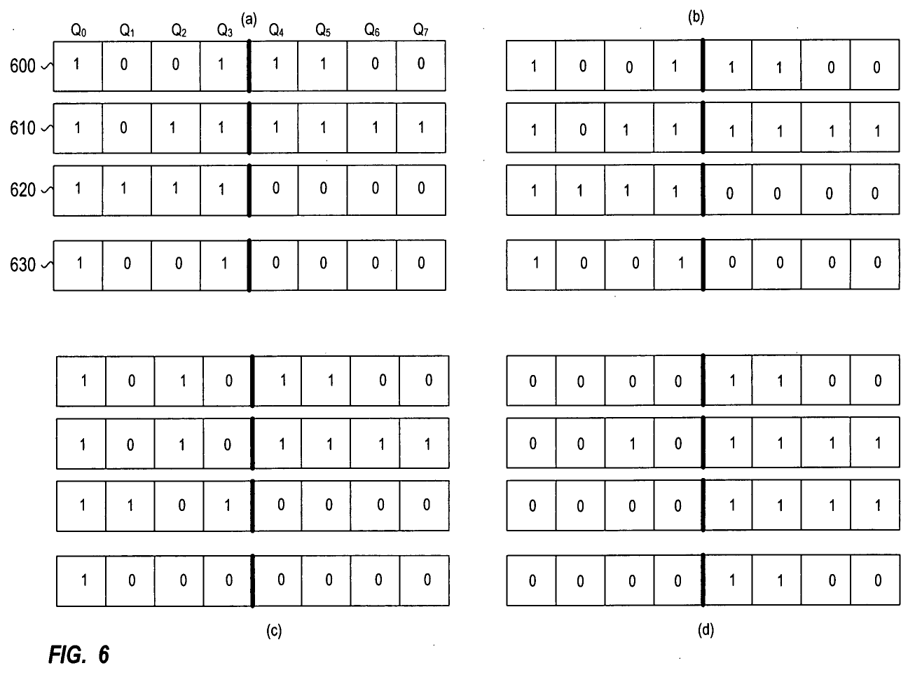

FIG. 6 illustrates an exemplary update of bit vectors as packets are dequeued. For simplicity we limit the number of queues to 8, four priority 1 queues (QO—Q3) and four priority 2 queues (Q4—Q7). Accordingly a bit vector 600, a credit bit vector 610, a level mask 620 and an AND bit vector 630 have 8 bits. Initially as illustrated in (a), queues 0 and 3-5 have data (bits set to 1 in the data bit vector 600) and queues 0 and 2-7 have credits (bits set to 1 in the data bit vector 610). Performing an FFS operation on the data bit vector 600 (e.g., 500) would result in selection of queue 0 and priority 1 queues accordingly. Accordingly, the mask 620 level assigned would be level 1 (e.g., 510). ANDing the data bit vector 600, the credit bit vector 610 and the level mask 620 results in the AND bit vector 630 (e.g., 520). It should be noted that the mask level filters out all queues not at priority 1 (e.g., priority 2 queues). Performing an FFS on the AND 630 results in a finding that queue 0 is the first queue at priority level 1 having both data and credit (e.g., 530). A packet is dequeued from queue 0 (e.g., 540) and the queue counts are updated (e.g., 550).

If we assume that there was multiple packets stored in queue 0 (e.g., 2) but only a single credit for queue 0, then once the data is dequeued the data count would be decremented by 1 (e.g., to 1) and the credit would be decremented by 1 to 0. As previously noted, in one embodiment the credit count may actually be reset to the weight. As the credits for queue 0 were used, the bit associated with queue 0 in the credit bit vector 610 should be updated (e.g., set to 0). However, queue 0 still has data so the credit bit may be reset. As illustrated in (b) the vectors 600-630 remained the same even though activity has occurred. As the AND bit vector 630 still has active bits the round is not complete and a packet is dequeued from the next queue at that priority level according to the algorithm (e.g., WRR).

The next queue having both data and credit is queue 3. A packet is dequeued from queue 3 (e.g., 540) and the queue counts are updated (e.g., 550). If we assume that there was only a single data packet and a single credit for queue 3, then once the packet is dequeued there would be no packets or credits remaining and the counts for queue 0 would go to 0. As illustrated in (c), the bit vectors 600, 610 are updated (e.g., set to 0) to reflect the fact that queue 3 now has no packets or credits (e.g., 560).

As queue 0 still has data and credit, the round (this priority level) would not be considered complete (e.g., 570 No). A packet is dequeued from queue 0 (e.g., 540) and the queue counts are updated (e.g., 550). If we assume that there was only a single data packet and a single credit for queue 0, then once the packet is dequeued there would be no packets or credits and the counts for queue 0 would go to 0. The bit vectors 600, 610 are updated (e.g., set to 0) to reflect the fact that queue 0 now has no packets or credits (e.g., 560). A determination is then made that the round is over (570 Yes) so the credit bits for priority 1 are reset.

Performing an FFS operation on the data bit vector 600 (e.g., 500) would result in selection of queue 4 and priority 2 queues accordingly. Accordingly, the mask 620 level assigned would be level 2 (e.g., 510). ANDing the data bit vector 600, the credit bit vector 610 and the level mask 620 results in the AND bit vector 630 (e.g., 520) that only allows priority level 2 queues. The updated bit vectors are illustrated in (d).

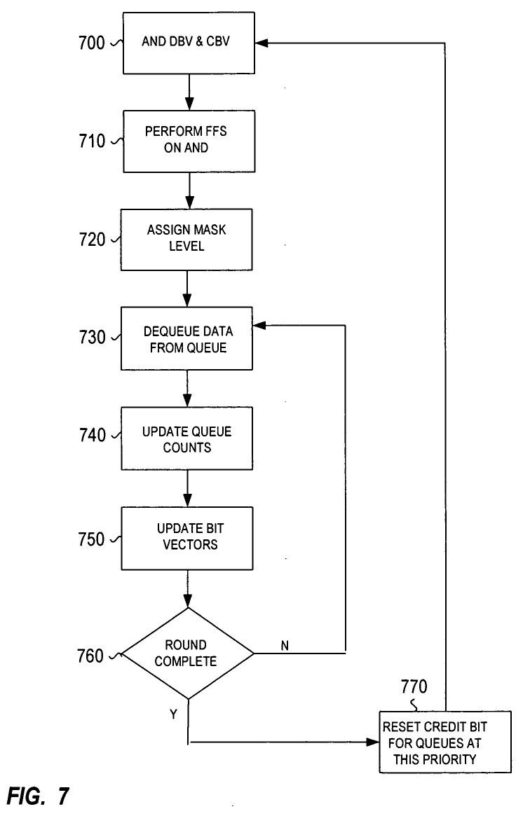

FIG. 7 illustrates an exemplary process flow for dequeuing packets from a hierarchical queue structure. The data vector and the credit vector are ANDed 700. The result is that any active bit indicates that the corresponding queue has both data and credit. An FFS instruction is performed on the AND to determine the first queue that has data and credit 710. As previously noted the bit vectors are organized by priority so the FFS operation will find the highest priority queues having data and credit. Once the queue is selected, a mask level is assigned 720, a packet is dequeued from the queue 730, and the data and credit counts for the queue are updated 740. After the queue counts are updated, the data and credit bit vectors are updated 750, if required.

After the bit vectors are updated, a determination will be made as to whether the round is complete for the selected priority level (whether there are any other queues at the priority level that have both data and credit) 760. The determination 760 includes ANDing the data bit vector with the mask level (and possibly the credit bit vector). Using the mask level filters out bits for queues at other priority levels. If the round is complete (760 Yes), the credit bits for the queues at that priority level (mask level) are reset (e.g., set to 1) 770. After the bits are reset an AND is performed on the updated bit vectors 700. If the round is not complete (760 No) indicating that there is at least one queue at the priority level having data (or data and credit), then the next queue for that priority is dequeued according to the scheduling algorithm (e.g., WRR) 730.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. It may be possible to implement, for example, some or all components of various embodiments in software and/or firmware as well as hardware, as known in the art. Embodiments may be implemented in numerous types of hardware, software and firmware known in the art, for example, integrated circuits, including ASICs and other types known in the art, printed circuit broads, components, etc.

The various embodiments are intended to be protected broadly within the spirit and scope of the appended claims.

What is claimed:

1. An apparatus comprising
a multi-level queue structure to store data, wherein said multi-level queue structure includes a plurality of queues segregated into more than one priority level; and
a scheduler to schedule transmission of the data from said multi-level queue structure, wherein said scheduler performs multi-level scheduling of said multi-level queue structure utilizing a single data bit vector organized by priority, wherein the single data bit vector indicates occupancy status of associated queues.

2. The apparatus of claim 1, wherein said scheduler selects a priority level for scheduling by finding first bit in the single data bit vector to indicate and associated queue has data, wherein the priority level of the selected queue is the priority level to be scheduled.

3. The apparatus of claim 2, wherein said scheduler finds the first bit by performing a find first bit set (FFS) instruction on the single data bit vector.

4. The apparatus of claim 2, wherein said scheduler utilizes a level mask to filter out non-selected priority levels.

5. The apparatus of claim 4, wherein said scheduler dequeues data from queues within the selected priority level and updates the single data bit vector as necessary.

6. The apparatus of claim 5, wherein said scheduler completes scheduling of the selected priority level when it is determined that the queues for the selected priority level have no data.

7. The apparatus of claim 6, wherein said scheduler determines the queues for the selected priority level have no data when an AND of the data bit vector and the level mask results in no active bits.

8. The apparatus of claim 1, wherein the queues of said multi-level queue structure are assigned weights and said scheduler further utilizes a single credit bit vector organized by priority indicating whether an associated queue has credits remaining for transmission of data therefrom.

9. The apparatus of claim 8, wherein said scheduler selects a priority level for scheduling and utilizes a level mask to filter out non-selected priority levels.

10. The apparatus of claim 9, wherein said scheduler dequeues data from queues within the selected priority level based at least in part on the single data bit vector and the single credit bit vector and updates the single data bit vector and the single credit bit vector as necessary.

11. The apparatus of claim 10, wherein said scheduler completes scheduling of the selected priority level when an AND of the single data bit vector, the single credit bit vector and the level mask results in no active bits.

12. The apparatus of claim 11, wherein said scheduler resets the credit bits for the queues in the selected priority level when scheduling of the selected priority level is complete.

13. The apparatus of claim 10, wherein said scheduler resets credit bit for a queue having data but no credit at the selected priority level.

14. The apparatus of claim 1, wherein the plurality of queues include data counters indicating how much data is in an associated queue and a masking level for the associated queue.

15. The apparatus of claim 8, wherein said plurality of queues include data counters indicating how much data is in an associated queue, credit counters indicating how much credit the associated queue has remaining, a weight for the associated queue, and a masking level for the associated queue.

16. A method comprising
storing data in a multi-level queue structure, wherein said multi-level queue structure includes a plurality of queues segregated into more than one priority level;
maintaining a single data bit vector organized by priority, wherein the single data bit vector indicates occupancy status of associated queues;
scheduling transmission of the data from said multi-level queue structure by utilizing the single data bit vector.

17. The method of claim 16, wherein said scheduling includes finding first bit in the single data bit vector to indicate an associated queue has data, wherein the priority level of the selected queue is the priority level to be scheduled.

18. The method of claim 17, wherein said finding includes performing a find first bit set (FFS) instruction on the single data bit vector.

19. The method of claim 17, wherein said scheduling further includes filtering out non-selected priority levels using a level mask.

20. The method of claim 17, further comprising
dequeuing data from queues scheduled within the selected priority level, and
updating the single data bit vector as necessary.

21. The method of claim 20, wherein said scheduling of the selected priority level is complete when it is determined that the queues for the selected priority level have no data.

22. The method of claim 20, wherein said scheduling of the selected priority level is complete when an AND of the data bit vector and the level mask results in no active bits.

23. The method of claim 16, wherein said storing includes assigning weights to the queues and further comprising maintaining a single credit bit vector organized by priority indicating whether an associated queue has credits remaining for transmission of data therefrom.

24. The method of claim 23, wherein said scheduling includes scheduling transmission of the data from said multi-level queue structure by utilizing the single data bit vector and the single credit bit vector.

25. The method of claim 24, further comprising
dequeuing data from queues scheduled within the selected priority level, and
updating the single data bit vector and the single credit bit vector as necessary.

26. The method of claim 25, wherein said scheduling is complete when an AND of the single data bit vector, the single credit bit vector and the level mask results in no active bits.

27. The method of claim 26, further comprising resetting the credit bits for the queues in the selected priority level when scheduling of the selected priority level is complete.

28. A store and forward device comprising
a plurality of interface cards to receive and transmit data, wherein said interface cards include a multi-level queue structure to store the data, wherein the multi-level queue structure includes a plurality of queues segregated into more than one priority level and assigned weights;
a switch to provide selective connectivity between said interface cards; and
a scheduler to schedule transmission of the data from the multi-level queue structure, wherein said scheduler performs multi-level scheduling of the multi-level queue structure utilizing a single data bit vector and a single credit vector, wherein the single data bit vector and the single credit vector are organized by priority, and wherein the single data bit vector indicates occupancy status of associated queues and the single credit bit vector indicates credit status of associated queues.

29. The device of claim 28, wherein said scheduler selects a priority level for scheduling by finding first bit in the single data bit vector to indicate an associated queue has data, wherein the priority level of the selected queue is the priority level to be scheduled.

30. The device of claim 29, wherein said scheduler completes scheduling of the selected priority level when an AND of the single data bit vector, the single credit bit vector and a level mask results in no active bits.
